(19) United States
(12) Patent Application Publication
(10) Pub. No.: US 2007/0220934 A1
(43) Pub. Date: Sep. 27, 2007

(54) Latch Arrangement

(76) Inventor: John Phillip Chevalier, London (GB)

Correspondence Address: DICKSTEIN SHAPIRO LLP, 1825 EYE STREET NW, Washington, DC, 20006-5403, US

(21) Appl. No.: 11/631,336

(22) PCT Filed: Apr. 27, 2005
(86) PCT No.: PCT/GB05/01605

§ 371 Date: Dec. 29, 2006

(30) Foreign Application Priority Data
Jul. 6, 2004 (GB) 0415159.3

(51) Int. Cl. E05B 65/12

(52) U.S. Cl. 70/237

(57) ABSTRACT

An automative door latch has, in one invention, a child-safety locking switch (102) using an overcentre spring (110), for exerting extra spring bias on a lock toggle lever (610) operating the interior door lock. In another invention, a mechanical cooperation between the two lock toggle levers (516) operating interior and exterior door locking ensures that manual operation of either handle, when unlocked, to cause the corresponding lever (516) to open the door or other closure, causes the corresponding pawl release assembly (514, 510) to move the other pawl release assembly (514, 510) to its unlocked, pawl-engaging position, if that other pawl release assembly had been at its locked, pawl non-engaging position. In a third invention, a motor drives the latch bolt (2) for closing the door, through two (907, 908) segment gears which mesh for only part of the turning movement of a rotary driving and indexing mechanism (906) which also operates door opening and locking. In a fourth invention, rotary drive sequence control for a rotary driving and indexing mechanism (906) is provided by a cam guide (930) and cam frame (950), the guide having endwalls and a central stop, the cam guide being shaped in the region of the end walls to guide the cam member in a unique direction through a unique loop relative to the cam guide, such that when the cam member is released from the central stop it is moveable to either end wall and then only to the central stop and not directly to the opposite end wall.

This invention relates to a latch arrangement for engaging an automotive door or other closure to a striker, and also to rotary drive sequence control apparatus for a rotary indexing mechanism driven by an electric motor. The inventions are particularly, but not exclusively, useful in automotive door latches controlled centrally, with automatic central door locking.

My publication WO 98/27301 disclosed a number of latch arrangements of this type using just a single electric motor, but capable of providing selective independent electrical and mechanical control of all the required latch functions: opening the door, and locking the interior and exterior door handle operations. It further disclosed automatic child safety mechanisms, in which the interior door handle is disabled either by a mechanical switch or by electronic control; and completion of door closure from a semi-latched to a fully latched position using motor drive.

I have also disclosed, in WO 01/69101, a centrifugal clutch suitable for conveying drive from an electrical motor to the relevant latch components, through a rotary driving and indexing member as disclosed in WO 98/27301.

A suitable electronic control system for this type of latch is further disclosed in my publication WO 03/004810, in which the rotary position of a driving and indexing member is sensed magnetically.

The purpose of the present invention is to reduce still further the size and weight of automotive door latches using the technology disclosed in my patent publications referred to above, so that they may be made more economically. Improved functionality is also desirable.

A first invention, intended to improve child safety in such a latch, comprises a latch arrangement for engaging an automotive door or other closure to a striker, comprising: a latch bolt displaceable between a latched position at which it engages the striker and an unlatched position at which it releases the striker; a pawl operative to latch or unlatch the latch bolt; a pawl release assembly coupled to the pawl for causing it to unlatch the latch bolt; a lever connectable, in use, to an interior door handle, for opening the door by unlatching the latch bolt; the pawl release assembly being moveable between two stable positions at the first of which it allows the lever to turn the pawl to release the latch bolt and at a second of which it prevents the lever so doing; and a child safety locking switch, comprising a spring acting on the pawl release assembly to variably bias it towards its second, locked position, and manually movable between active and inactive stable positions, at the active position of which the variable biasing force is strong enough to override any other force acting on the pawl release assembly, whereby to ensure that it remains at or it returns to its second position, and at the inactive position of which the variable biasing force is weak enough to allow other elements of the latch assembly to retain the pawl release assembly at its first, unlocked, position.

This provides a simple and reliable mechanical arrangement for selecting child safety operation in respect of an interior door handle, for example by turning a switch accessible through the housing for the latch arrangement.

In some circumstances it is desirable to provide a manual override for the locking of the interior and exterior door handles, for example. Accordingly a second invention provides a latch arrangement for engaging an automotive door or other closure to a striker, comprising: an electric motor; a latch bolt displaceable between a latched position at which it engages the striker and an unlatched position at which it releases the striker; a pawl operative to latch or unlatch the latch bolt; a driving and indexing member coupled to be driven by the motor and having at least projection extending therefrom; at least two pawl release assemblies coupled to the pawl for causing it to unlatch the latch bolt; at least two coupling members, each being associated with a respective pawl release assembly and moveable between a locking position, at which it disengages the corresponding pawl release assembly from the pawl, and an unlocking position at which it engages the corresponding pawl release assembly with the pawl; each of the coupling members being arranged to be driven between its locking and unlocking positions by the projection or by one of the projections; whereby the driving and indexing member is driveable electrically to cause the projection or projections selectively to drive the coupling members to engage the pawl release assemblies; and levers connectable, in use, to respective handles for opening the door by unlatching the latch bolt; each pawl release assembly being moveable between a first position, at which it allows the corresponding lever to turn the pawl to release the latch bolt, and a second position at which it prevents the lever so doing; the pawl assemblies having co-operating formations arranged such that manual operation of either handle, when unlocked, to cause the corresponding lever to open the door or other closure, causes the corresponding pawl release assembly to move the other pawl release assembly to its unlocked, pawl-engaging position, if that other pawl release assembly had been at its locked, pawl non-engaging position.

Preferably, the latch arrangement comprises levers connectable, in use, to respective sill knob and key controls for manual locking respectively of one pawl release assembly, corresponding to the interior handle, and of both pawl-release assemblies, corresponding to interior and exterior handles, the arrangement being such that opening by the interior handle ensures that the exterior handle operation is unlocked; and that opening by the exterior handle ensures that the interior handle operation is unlocked.

In a preferred embodiment, this allows electrical child safety (where the disabling the interior door handle is controlled automatically using the electric motor) to function only once, and then to be reset off by mechanically pulling the exterior door handle. This can be an advantage for example when a car is used for different passengers at different times: once child passengers in the rear have been taken to school for example, the next passengers would not require child safety.

Further, in the preferred embodiment, if the sill knob is locked, the interior door handle may still be operated, allowing the rear passengers to open the door; this resets the sill knob to unlocked status, and prevents occupants from inadvertently locking themselves out of the car.

A third invention is aimed at minimising the necessary size and power of the electric motor for operating all the necessary latch functions. Accordingly the third invention provides a latch arrangement for engaging an automotive door or other closure to a striker, comprising: an electric motor; a driving and indexing member coupled to be driven by the motor and having at least one projection extending therefrom; a latch bolt displaceable between a latched position at which it engages the striker and an unlatched position at which it releases the striker, and being selectively drivingly coupled to the driving and indexing member; a pawl operative to latch or unlatch the latch bolt; an actuation member coupled to the pawl for causing it to unlatch the latch bolt and arranged to be driven by the projection or by one of the projections; whereby the driving and indexing member is driveable electrically to cause the projection or projections to drive the actuation member to cause the pawl to unlatch the latch bolt to open the door or other closure; the arrangement being such that continued motion of the driving and indexing member beyond the position at which it drives the actuation member causes it to drive the latch bolt, whereby the door or closure may be drawn to a fully closed position under the power of the motor; the driving and indexing member being coupled to the latch bolt by means of a reduction gearing which is disengaged over a rotary range of the driving and indexing member at which it drives the actuation member.

By sequencing the operations of opening the door and of closing the door, the electric motor is not required to deliver torque to carry out both functions simultaneously, so a lower power motor is sufficient. Further, decoupling of the powered door closing function from the control of the actuation member is ensured by arranging for the reduction gearing to be disengaged over a rotary range of the driving and indexing member. Preferably, this disengagement is achieved by the use of meshing segment gears, delivering drive from the driving and indexing member to the latch bolt. In preferred embodiments, the driving and indexing member also operates locking and unlocking of the interior and exterior door handle operations, and these are also sequenced so that they are not required to be done simultaneously with door closing. Further, in preferred embodiments, reduction gearing is selected to allow the use of a smaller electric motor than hitherto had been possible, with the gear ratio being further reduced between the driving and indexing member and the latch bolt.

In many latch arrangements, the driving and indexing member operates bi-directionally, and operates through a rotational sequence. Typically, the rotary driving and indexing member is operable in discrete sectoral zones, i.e. it performs different functions over discreet rotational ranges. The electronic control system for the motor needs to apply rotational drive in the appropriate direction to carry out the required function, without continued motion of the driving and indexing member into the next zone. The system has to be able to recognise that the rotary driving and indexing mechanism has reached the required position. It is then able to initiate the required movement, in the required direction, for the next desired function. In arrangements such as I described in WO 03/004810 a magnetic sensor arrangement associated with the driving and indexing member senses its position and feeds this information back to the control system. However, it is desirable in some situations to avoid this complexity, and to control the sequence of operations more mechanically.

Accordingly, the fourth invention provides rotary drive sequence control apparatus for a rotary indexing mechanism driven by an electric motor, comprising a cam guide fixed to the motor's stator and a cam frame supporting a cam member and mounted for rotation with the motor's rotor and, in use, with the indexing mechanism; the cam guide comprising end walls defining respective limits of rotational movement of the cam member in clockwise and anti-clockwise directions, and a resiliently deformable, radially-extending stop disposed centrally between the end walls; the cam frame being deformable radially between an extended position, at which the cam member is free to rotate past the central stop, and a retracted position, at which the cam member abuts the central stop, the cam member being resiliently biased towards the extended position; the central stop having end projections directed towards the respective end walls shaped for retaining the cam member, against its resilient bias to its extended position, when and only when the cam member is pushed rotationally against the central stop, so that it releases the cam member when the torque acting on it falls below a predetermined level; and the cam guide being shaped in the region of the end walls to guide the cam member in a unique direction through a unique loop relative to the cam guide, such that when the cam member is released from the central stop it is moveable to either end wall and then only to the central stop and not directly to the opposite end wall.

This invention also provides a rotary indexing mechanism comprising a motor output drive coupled to drive an indexing member, and a rotary drive sequence control apparatus as defined above mounted co-axially, with the cam guide fixed to the motor and the cam frame fixed to the motor output drive; whereby the indexing mechanism is constrained to operate in two sectoral zones such that movement between the zones is indirect and delayed but movement within a zone is unrestricted.

Preferably, the motor is coupled to the output drive through a centrifugal clutch such that the clutch decouples drive below a predetermined speed, whereby the abutment of the cam member against the central stop causes the motor drive to decouple after a predetermined interval and then allows the cam member to be released from the central stop such that further operation of the motor in either direction drives the cam member to the corresponding end wall.

The invention thus enables a mechanical arrangement to introduce a time delay in the rotary motion of the driving and indexing member. This can replace the positional feedback which would otherwise be required; once the motor has completed the desired first function in the latch, the motor is forced to stop as the cam member hits the central stop; after a predetermined delay, as the centrifugal clutch stops the motor, the driving and indexing member is once again free to move in either direction, depending on the next function it is required to perform.

The rotary drive sequence control apparatus of this fourth invention is expressed broadly, since it is envisaged that it has applications beyond those described below in relation to the preferred embodiments of the latch arrangement. In principle, it is applicable to any rotary driving mechanism operable in two rotational directions.

In order that the inventions may be better understood, preferred embodiments will now be described, by way of example only, with reference to the accompanying drawings, in which:

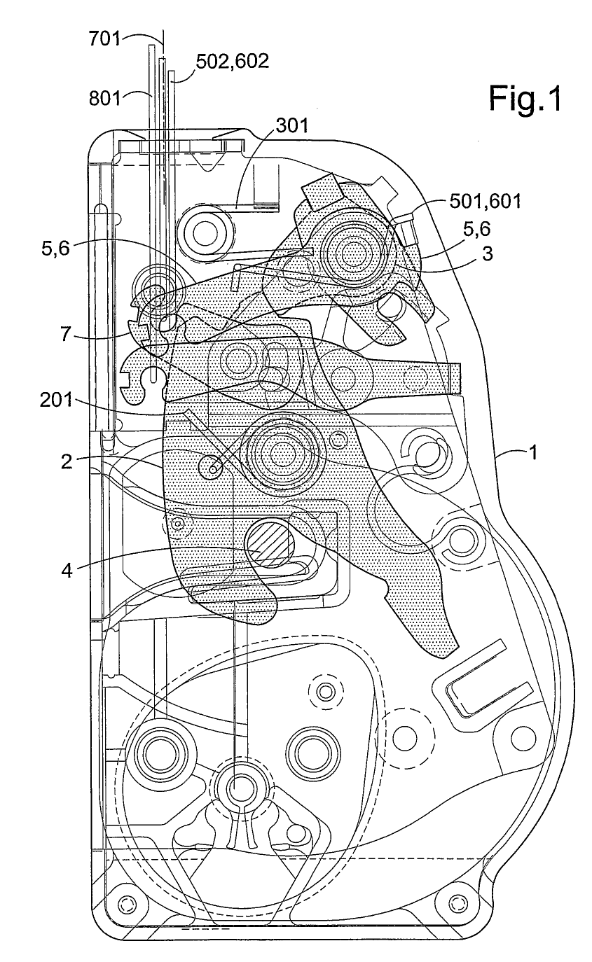

FIG. 1 is a plan view of part of an automotive door latch embodying the inventions, but with some parts omitted for clarity;

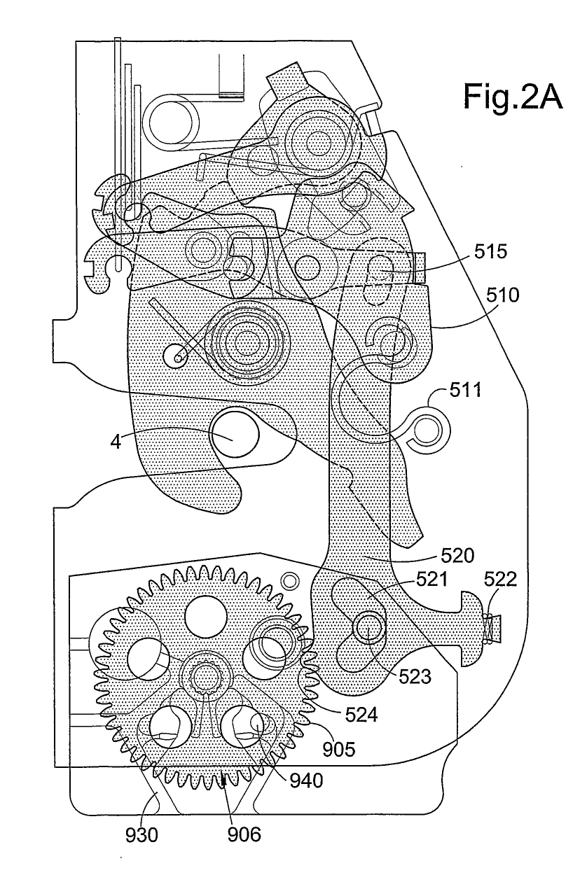

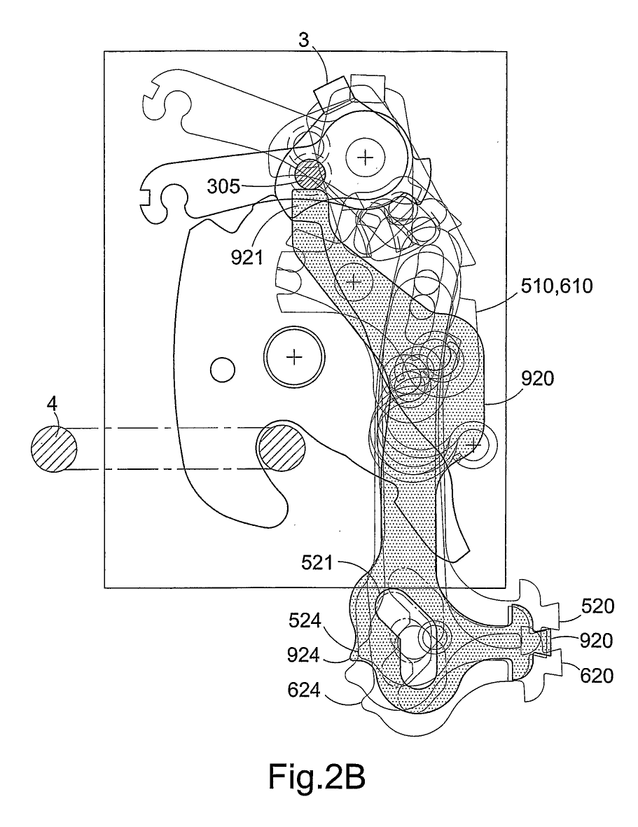

FIG. 2A is an enlarged plan view of parts of the latch arrangement of FIG. 1;

FIG. 2B is a further plan view of parts of the latch arrangement of FIGS. 1 and 2A;

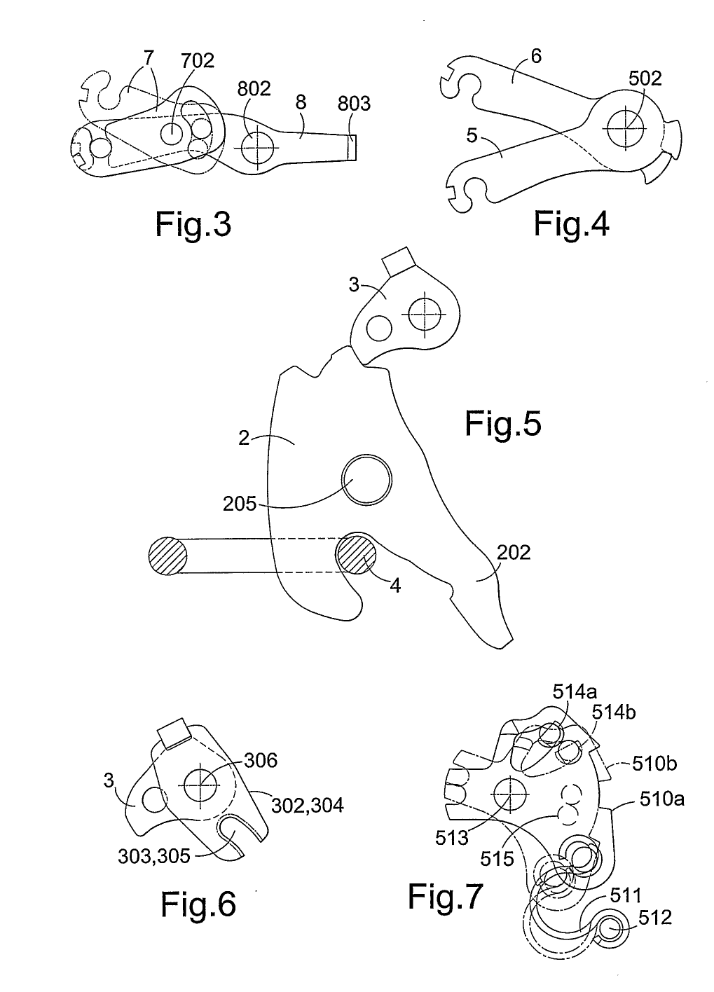

FIG. 3 illustrates a sill knob lever and a key locking lever in the arrangement of FIG. 1;

FIG. 4 illustrates manual release levers for coupling with the interior and exterior door handles, being part of the latch arrangement of FIG. 1;

FIG. 5 illustrates the latch bolt and pawl of the latch arrangement;

FIG. 6 illustrates the pawl and drive dog of the same arrangement;

FIG. 7 illustrates two sequential positions of one of the pawl release assemblies associated with one of the door handles;

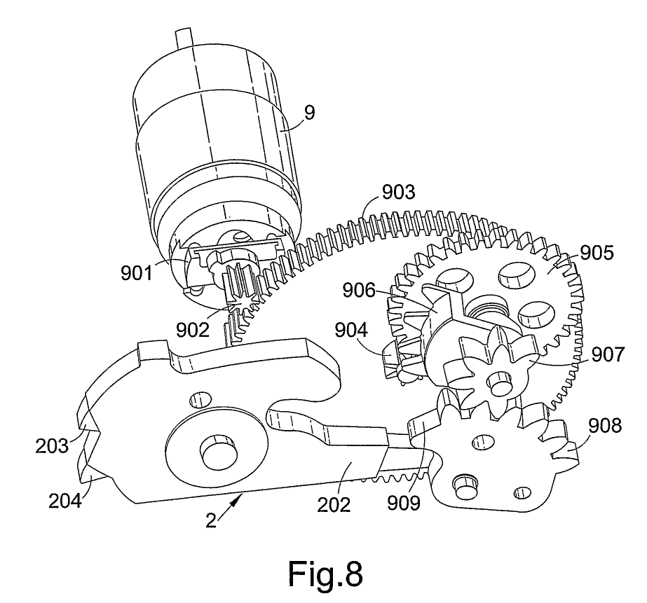

FIG. 8 is a perspective view of the motor drive and reduction gearing arrangement including the rotary driving and indexing member and latch bolt, of a latch arrangement according to a first embodiment;

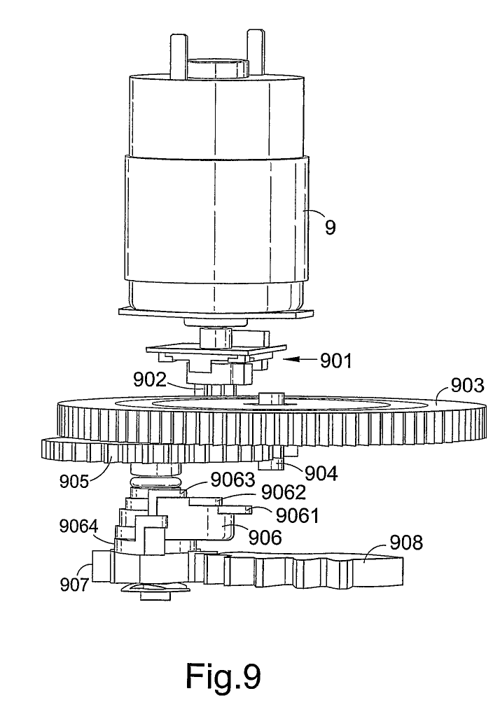

FIG. 9 is a side view of the motor drive arrangement of FIG. 8;

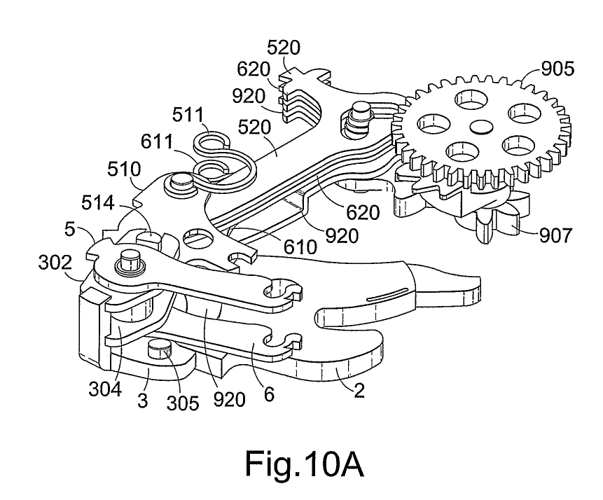

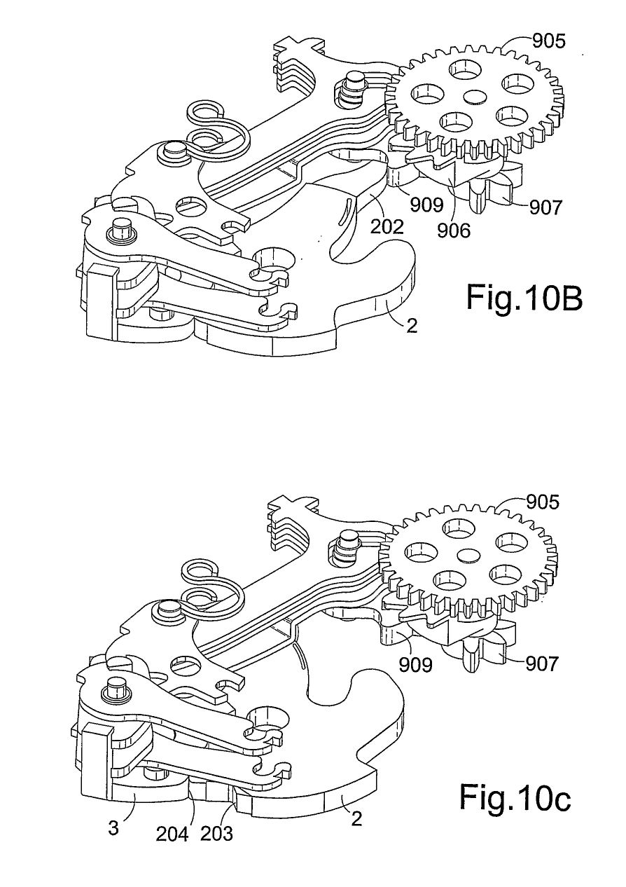

FIGS. 10A, 10B and 10C show different positions of the latch bolt together with parts of the latch arrangement involved in unlatching the pawl;

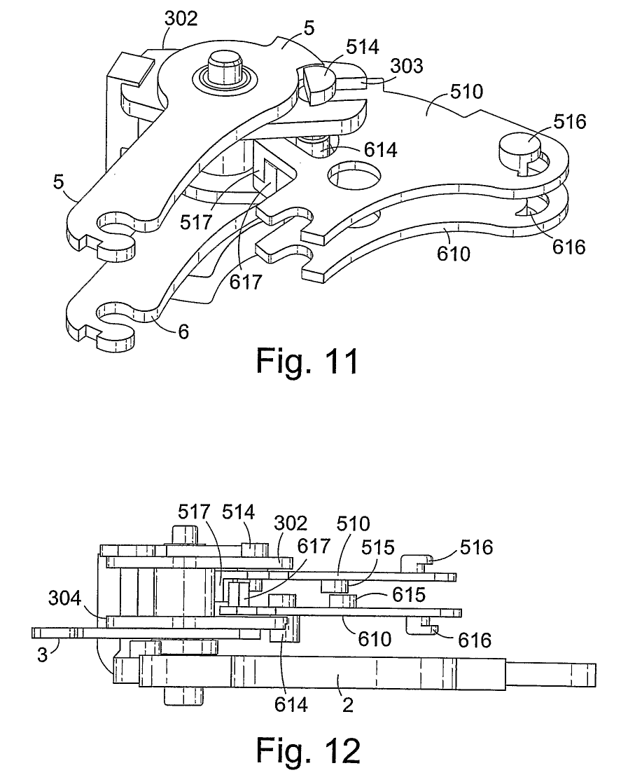

FIG. 11 is an enlarged view of the two pawl release assemblies of the latch arrangement, together with the pawl and the manual release levers for the two door handles;

FIG. 12 is a side view of the arrangement of FIG. 11;

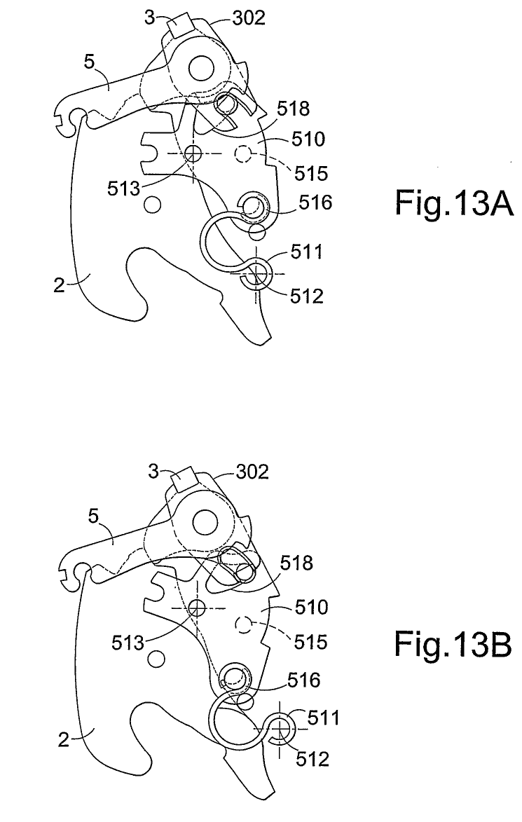

FIGS. 13A and 13B are illustrations of one of the pawl release assemblies shown respectively in its unlocked and locked positions;

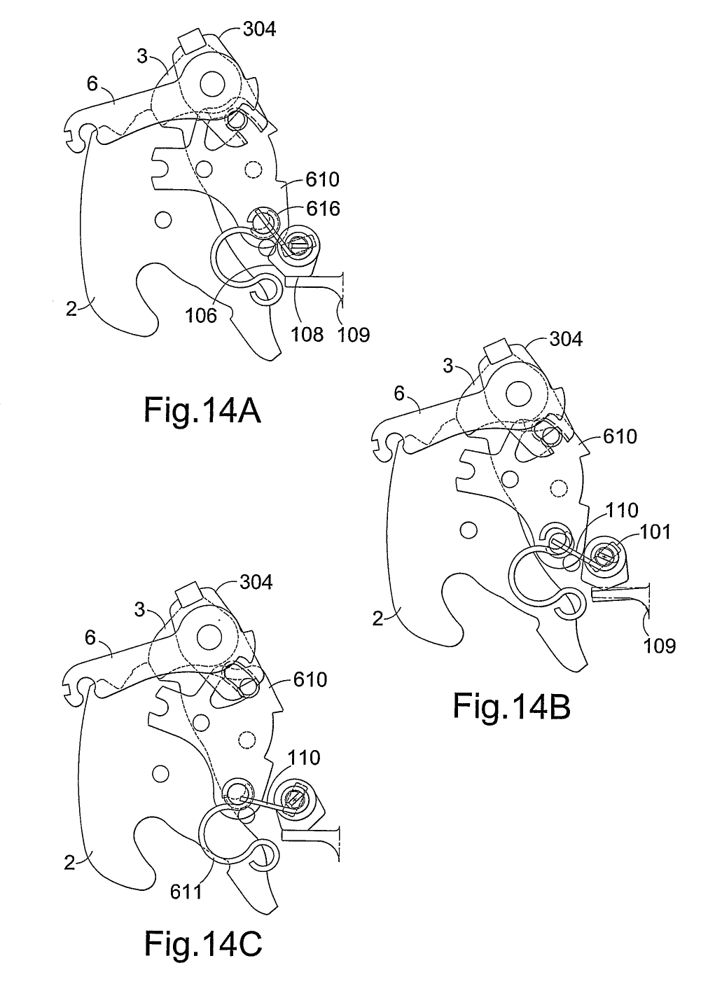

FIGS. 14A, 14B and 14C illustrate different positions of a child safety locking mechanism associated with the pawl release assembly of FIG. 13A and FIG. 13B;

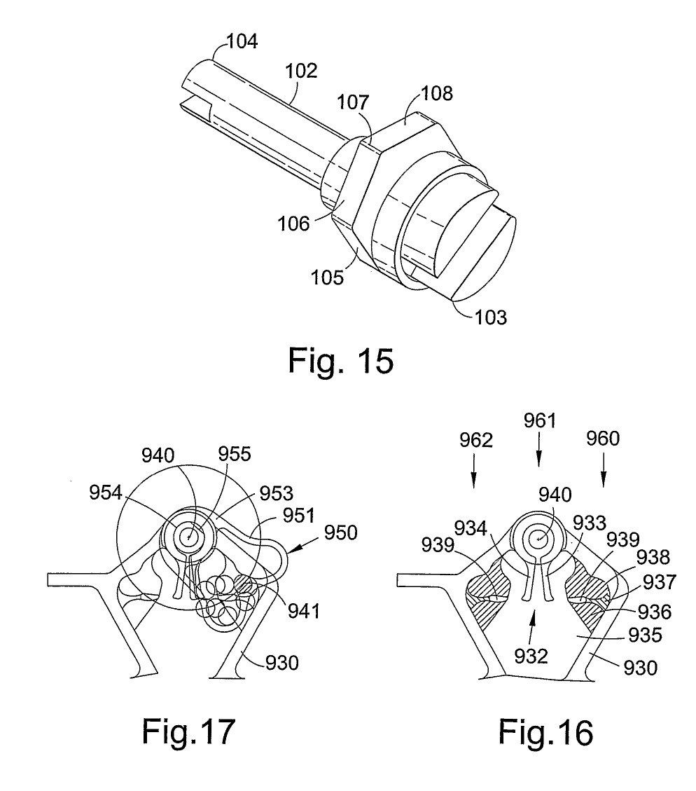

FIG. 15 is a perspective view of the child safety locking switch of FIGS. 14A to 14C;

FIG. 16 is a plan view of a cam guide fixed to the frame of the latch arrangement of FIG. 1, for controlling the rotary motion of the driving and indexing member of a second embodiment of the invention;

FIG. 17 is a plan view of a cam frame and cam member shown over the cam guide of FIG. 16, illustrating a sequence of positions of the cam member in operation within one sectoral zone;

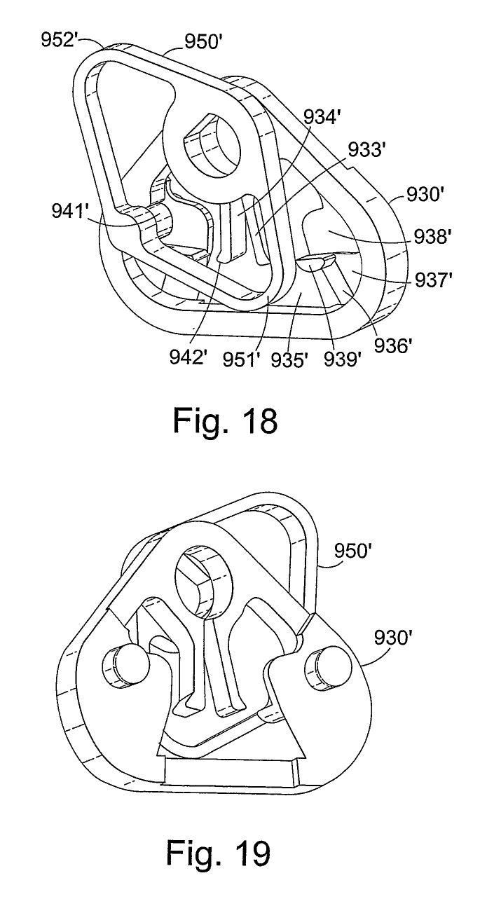

FIG. 18 is an enlarged view of an alternative configuration of the cam guide and cam frame of FIGS. 16 and 17; and

FIG. 19 is a view corresponding to FIG. 18 from the other side.

Automotive door latches embodying the inventions will now be described, initially with reference to FIGS. 1 to 7. The latch is housed in a steel casing 1 with a plastics outer layer, with approximate dimensions 10 cm×5 cm×2 cm. The approximate weight of the latch is 600 g including the electric motor but excluding external cables and wires.

As usual, the latch case 1 is secured to the vehicle door so that it engages a U-shaped striker 4 projecting from the door frame of the vehicle. When the vehicle door is fully closed, it resiliently compresses a weather shield (not shown) which then helps to open the door when the latch releases the striker. A typical passenger car will have four such latch arrangements on respective front and rear doors, and will have a simplified version of the latch on the boot or tailgate. The latches are controlled by a central control unit (not shown) of the type described for example in WO 03/004810. Electric current is supplied to an electric motor 9 from the central control unit, with a voltage polarity according to the required direction of rotation of the motor. The latch is coupled to a door knob or sill knob, typically on an upper inner surface of the door; to a mechanical key arrangement accessible by a key from the door exterior; and to interior and exterior door handles (or to a knob or latch on the exterior of the boot or tailgate, as appropriate). These coupling arrangements are described below. The latch controls the opening and closing of the door, and its operation from the door handle is selectively unlocked or locked dependent on the sill knob and key positions, i.e. mechanically, but also electrically using the central control unit and the electric motor 9. The electrical and mechanical operation of each function of the latch are entirely independent of each other, and do not interfere with each other; in the event of electrical failure, the lock is still operable mechanically, and the lock operation does not jam. The lock can be operated electrically, independently of the mechanical controls.

The latch bolt has an extended limb 202 the end of which is operatively engaged by a segment gear 908 for completing closure of the door under electric power, from the semi-latched position, as described below in greater detail.

A claw or latch bolt 2 is mounted for rotation about a pivot axis 205 in the plane of the latch 1. As shown more clearly in FIG. 8, the latch bolt 2 has a J-shaped opening for retaining the striker 4, which it engages with a cylindrical surface 203. The latch bolt 2 is rotationally biased by a torsion spring 201 which is sufficiently strong to partly open the door and to move the latch bolt to its fully unlatched position, cocked and ready to be struck again by the striker 4 when the door is re-closed. As the door is pushed closed, it first causes the latch bolt to rotate to a semi-latched position, at which a pawl 3 engages a shoulder 203, FIG. 8. Continued rotation of the latch bolt under the force of the striker 4 brings it to a fully latched position at which a further shoulder 204 engages the pawl 3.

The pawl 3 is mounted pivotally on an axis 306, FIG. 6, and is permanently engaged rotationally with a pair of axially-spaced dogs 302, 304 mounted co-axially at 306. The dogs may be formed integrally with the pawl. The dogs each have a U-shaped opening 303, 305 for receiving rotational drive from a cam pin 514, 614 respectively, held by corresponding lock toggle levers 510, 610, described below. The dogs selectively convey drive from respective exterior and interior manual release levers 5, 6, FIG. 4, which are linked by cables 502, 602 (FIG. 1) to respective exterior and interior door handles.

Mechanical locking is controlled by a sill knob lever 7, mounted for rotation on an axis 702, and a key locking lever 8, mounted for rotation on an axis 802. These levers 7, 8 are operatively linked by a pin in a slot as shown in FIG. 3, such that locking by the key causes the sill knob lever to move to its locking position. As is conventional, the sill knob lever 7 locks or unlocks the interior door handle operation, whilst the key locks or unlocks both interior and exterior door handle operations. A lug 803 on the key locking lever 8 engages with both key toggle levers 510, 610, to cause locking or unlocking of both the exterior door and interior door locking arrangements. The sill knob lever 7 is connected to a cable 701 linked to the sill knob, and the key locking lever 8 is connected to a corresponding cable 801 which connects to the key mechanism in the door.

As shown in FIG. 1, the pawl 3 has a torsion return spring 301, and each manual release lever 5, 6 has its own torsion return spring 501, 601. As shown in FIGS. 2A and 2B, electrical control of the locking and unlocking of the interior and exterior door handles, and of the release of the latch bolt for door opening, is performed by the electric motor 9 which drives bi-directionally a driving and indexing member 906, FIG. 8, which in turn drives two parallel and superposed locking sliders 520, 620 and an opening slider 920. All three sliders are shown in FIG. 2B, and just the exterior locking slider 520 is shown in FIG. 2A. All three sliders 520, 620, 920 have cruciform projections to which respective dual return springs 522, FIG. 2A are attached. This enables the sliders to reciprocate lengthwise of the latch, in the plane of the latch, as a cam pin 523, fixed to the latch case, guides a slider cam slot 521 which is arcuate. The driving and indexing member 906, as shown in FIGS. 8 and 9 most clearly, has three axially spaced projections 9061, 9062 and 9063 at different rotational positions, which are positioned for engaging the corresponding projections 524, 624 and 924 of the locking sliders and the opening slider. A fourth projection is provided but is not used in this embodiment. Rotary indexing movement of the driving and indexing member 906 sequentially engages and slides the respective locking and opening sliders, in the lengthwise direction corresponding to the direction of rotation, to achieve the required function.

As shown in FIG. 2A, the exterior locking slider 520 has a slot at one end which engages with a pin 515 on the corresponding exterior handle release lever 5. The interior locking slider 620 has a similar interconnection with the interior handle release lever 6. The opening slider 920, also shown in FIGS. 10A and 10B, has an end projection 921 which abuts against a pin 305 projecting from the surface of the pawl 3. Thus the opening slider 920 can directly engage and rotate the pawl 3 to release the latch bolt, for opening the door. Once the locking sliders or opening slider has been actuated by the driving and indexing member, they spring back to their neutral positions under the action of the return springs 502, once they are disengaged by the corresponding projections of the driving and indexing member. This avoids interference with the mechanical operation of the locking and door opening functions. Some of the possible positions of the sliders are shown in FIG. 2B to illustrate their paths of movement, both translating and rocking.

In a first embodiment, a cam frame and cam guide assembly 930, 950 of FIGS. 1, 2A and 16 to 19 is omitted, and the rotary position of the driving and indexing member 905 (or of a linked component) is sensed e.g. by a magnetic ring sensor providing a signal to the central control unit. The two segment gears 907, 908 of FIG. 8 deliver torque to the latch bolt 2 to close the door, as described below.

In a second embodiment, the electric motor controls the door opening and locking, but there is no powered door closing. The movement of the rotary driving and indexing member is time-controlled using the cam frame and cam guide assembly 930, 950 described below with reference to FIGS. 16 to 19, but also shown in part in the lower left hand portion of FIGS. 1 and 2A. The two segment gears 907, 908 of FIG. 8 are omitted from this embodiment, as no drive is coupled to the latch bolt 2. In other respects, the two embodiments are the same, so the description will not be repeated.

The following description relates to the first embodiment.

With reference to FIGS. 8 and 9, the electric motor 9, powered by a DC voltage whose polarity determines the direction of rotation, has an output spindle coupled to an output gear 902 through a centrifugal clutch 901 of the type described in my specification WO 01/69101. The rotational drive is transmitted only when the rotational speed exceeds a predetermined threshold. Thus when the driven gears resist rotation sufficiently, the electric motor spindle is decoupled. This prevents mechanical drag from the electric motor in the event that the latch bolt or the locking assemblies have to be moved mechanically, and avoids jamming. It is an important part of the sequence timing for the different operations of the driving and indexing member, as described below, allowing automatic operation of the electrical functions without positional feedback.

Drive from the output gear 902 to an intermediate gear 903 with which it meshes is at a gear ratio of 12 to 1. A pinion 904 mounted for co-rotation with the intermediate gear 903 transmits the drive to a further gear 905, the gear ratio between gears 904 and 905 being 5 to 1. The further gear 905 rotates with the driving and indexing member 906 and also with a first segment gear 907, and indeed these components may be formed integrally. Thus the gear reduction ratio from the motor output drive through to the driving and indexing member 906 is 60 to 1. In other embodiments it may be in the range of between 40 and 100, preferably 40 and 80, more preferably 50 and 70, to one. The first segment gear 907 has teeth extending over a rotational range of approximately 220 degrees or about two-thirds of the full circle. It is in meshing engagement with the second segment gear 908. The angular range of the six teeth on the second segment gear 908 is approximately 90 degrees or a quarter turn: the number of teeth corresponds to the number on the first segment gear, but the ratio of radii is approximately 2.5 to 1, and in other examples between 2 and 4, preferably 2 and 3; so this provides a further gear reduction ratio from the driving and indexing member. A projection 999 radially spaced from the last of the six teeth on the second segment gear 908 is disposed for driving the tip of the extension 202 of the claw or latch bolt 2, as shown in FIGS. 8 and 10b. This enables the driving and indexing member to drive the latch bolt from its semi-latched position, shown in FIG. 10b, to its fully latched position, shown in FIG. 10c, whereupon the second segment gear returns to its initial position. Rotation of the latch bolt is performed over a discrete range of angles of the driving and indexing member, entirely separate from the angular range of operation of the locking and opening sliders. This minimises the torque requirements of the electric motor 9. In this example, the extended length of the projection 202 of the latch bolt also gives the electrical drive a mechanical advantage over the striker 4 which engages at the cylindrical surface 203 at a substantially lower radius. Typically, the ratio of radii here is 3 to 1, and in other examples it is greater than 2, preferably between 2 and 4. Thus the cumulated reduction gearing from the motor through to the latch bolt to the striker in this example is 60×2.5×3=450. With typical values of the torsion spring 201, and compressibility of the weather seal around the door, the door closing function may be achieved satisfactorily with a standard DC motor providing an output of some 30 mNm, operating at between 10,000 and 12,000 rpm.

All the functions of the driving and indexing member 906, comprising door opening, locking, unlocking and powered closing, are carried out over a rotary range of the driving and indexing member less than 360°, a full turn. The door opening, locking and/or unlocking functions are done typically in 10-15 ms, and the powered door closing in about 1 second. This is substantially better than is possible with conventional latches of this type.

The operation of the locking assemblies will now be described with reference particularly to FIGS. 10 to 13. Both locking assemblies are similar and are superposed on common axes of rotation. They are operable electrically from the driving and indexing member and also mechanically from the corresponding release levers. The arrangement is such that electrical and mechanical operations are independent and non-interfering.

The exterior handle locking assembly will be described in detail with reference to FIGS. 13A and 13B. It will be understood that the interior handle locking assembly works similarly. A lock toggle lever 510 pivotally mounted at 513 carries a spring mounting 516 at one end, on which is mounted one end of a compression spring 511 whose other end is fixedly mounted at 512 to the case 1. The lock toggle lever 510 is rotatable between two stable positions as shown respectively in FIGS. 13A, the unlocked position, and FIG. 13B, the locked position. This is because the spring 511 is configured as an over-centre spring, such that the spring mounting 516 is forcibly rotated away from the line joining the pivot points 512, 513 of the spring and the lock toggle lever 510 respectively. At the other end of the lever, a generally triangular slot 518 carries a peg or pin 514 which is generally cylindrical but which projects axially through the corresponding drive dog 302 to engage the corresponding handle release lever 5; at its end, which engages the end of the handle release lever 5, the pin 514 has a flat, and is therefore D-shaped. The diameter of this D-shaped end portion is greater than the width of the slot 303 in the dog 302, to assist in retaining it for sliding movement along that slot, radially of the dog, between an unlocked position shown in FIG. 13A and a locked position, shown in FIG. 13B. In the unlocked position of the pin 514, rotational drive from the handle release lever 5 is transmitted to the dog, but at the locked position it is not. The pin 514 is free to move within the triangular slot 518, whose edge acts as a camming surface on the pin. The inner end surfaces of the two pins 514, 614 slide close to each other but do not interfere, as shown in FIG. 11 and FIG. 12.

Actuation of the lock toggle levers 510, 610 by the corresponding sliders 520, 620 is through inner projecting pegs 515, 615, shown also in FIG. 2A and FIG. 2B, sliding along elongate slots in the sliders.

Inward projecting pegs 517 and 617 on the respective lock toggle levers 510, 610 allow the superposed toggle levers to co-operate with each other, to provide a manual override locking mechanism. Each such peg 517, 617 is arranged to cam against the pin 614, 514 of the other locking assembly. When one of the handles is unlocked, and it is operated manually to move the release lever and to turn the dog through the pin, that pin cams against the projecting peg of the other toggle lever, if that other toggle lever is in its locked position, to push it towards its unlocked position. In this example, the camming motion continues until just past the over-centre position of the spring for the toggle lever being pushed. Thus the toggle lever continues its motion under the force of the over-centre spring to move to its unlocked position. In this way, manual operation of either handle to open the door causes the status of the locking of the other handle to move to, or to remain at, unlocked. At the same time, the handle release lever causes the pawl 3 to release the latch bolt 2 to open the door.

This manual override locking mechanism has two practical advantages. First, it allows electrically-controlled child safety, whereby the interior door handle is locked permanently, to function only once, and then to be reset off by mechanically pulling the exterior door handle. So when young children are taken in the rear seats, the driver can set electrical child safety on, but when the driver opens the rear passenger door to allow the young children to leave the car, electrical child safety is reset; his next passengers in the rear may be adults who would be irritated by child safety. The second practical advantage is that if the sill knob is locked, and the interior door handle is operated, the rear passengers can open the door and reset the sill knob to its unlocked position; closing the vehicle doors then does not lock them, so this arrangement prevents inadvertent locking of the driver and passengers out of the vehicle.

Accordingly, the lock toggle levers may be moved either by the key, in which both are operated in one direction to the locking position; or by the sill knob, in which only one is operated, corresponding to the exterior door handle; or by an electrical switch which controls the electric motor through the central control arrangement. Mechanical and electrical operation are independent at all phases of operation of the latch assemblies.

The over-centre spring mechanism of the lock toggle levers has a further feature, namely that unlocking can be achieved regardless of the rotary position of the corresponding handle release lever. If a handle is locked but is pulled anyway, and the handle is unlocked whilst the release lever is turned (clockwise in FIGS. 13A, 13B), then the handle will indeed be unlocked when it is operated a second time.

The child safety locking mechanism will now be described with reference to FIGS. 14 and 15. Although not shown in FIG. 1, the case 1 has a child safety operating keyhole 101, FIG. 14b, allowing access to a child safety switch 102, FIG. 15. In this example, the switch 102 has a slot 104 at one end, for operation by a blade such as a screw driver through one side of the latch case, and a larger and wider slot 103 at the opposite end, for normal user operation through an opening at the opposite side of the case. The larger slot 103 may be engaged for example by a coin. The switch 102 is formed integrally with a polygonal cam 105 having inclined flat surfaces 106, 108 separated by a narrow edge or region 107 of greater radius. This cam 105 is disposed to turn between two bi-stable positions, shown in FIGS. 14A and 14C, at which the flat surfaces 106, 108 engage the surface of a leaf spring 109 mounted on the casing. This provides an over-centre spring arrangement, such that movement to the intermediate position, shown in FIG. 14B, at which the edge 107 engages the leaf spring 109, makes it metastable. The locking switch 102 is coupled to a torsion spring 110 which has an extending arm engaging with one end of the interior lock toggle lever 610. In this example, it engages with the spring mounting 616. The torsion spring 110 of the child safety locking mechanism is strong enough to ensure that the lock toggle lever 610 stays at its locked position; if the lock toggle lever is rotated to its unlocked position either mechanically or electrically, it is unable to stay at that position, and it is forced back to its locked position as shown in FIG. 13A. Thus the springs 110 and 611 are chosen carefully such that the torque applied by the child safety locking mechanism is substantially greater than that provided by the over-centre spring arrangement of the lock toggle lever. This however is true only when the child safety locking mechanism is switched on, in the configuration in FIG. 14C. It is also important that when child safety is switched off, as shown in FIG. 14A, the torque from the child safety spring 110 is substantially less than the torque applied by the over-centre spring 611, allowing the lock toggle lever to assume and to remain at its unlocked position.

The second embodiment of the invention is simpler in that it does not have electrically-powered door closing. In other respects it is similar to the embodiment of FIGS. 2B to 15.

The time controlled cam sequencing of the rotary driving and indexing mechanism of this embodiment will now be described with reference to FIGS. 16 to 19; reference may also be had to FIGS. 2A and 2B showing the arrangements of FIGS. 16 and 17 together with the co-operating drive components. The components illustrated to a larger scale in FIGS. 18 and 19 represent alternatives to those shown in FIGS. 16 and 17, but their function is entirely analogous.

This arrangement allows the bi-directional electric motor to operate the locking and opening functions in the desired sequence without the need for positional feedback of the rotary position of the driving and indexing member. Rotational movement of the driving and indexing member occurs over three zones or sectors, corresponding to the latch functions that are to be performed. In a central sectoral zone, the latch bolt is free to rotate. On either side of that zone, there is a zone for operating the respective locking sliders, such that either zone is selected depending upon whether electrical locking or unlocking is required of the interior or the exterior door handle control. The purpose of the mechanical camming arrangements shown in FIGS. 16 to 19 is to limit the effect of continued motor rotation to just one desired sequence of operations, and to cause the motor to stop driving the driving and indexing member for a predetermined interval. This is achieved by blocking rotary motion, causing the centrifugal clutch to disengage, and then allowing re-engagement in either of the two directions of rotation: there is an inherent delay through the operation of the mechanical arrangements shown in FIGS. 16 to 19, and the centrifugal clutch.

A cam guide 930 is mounted fixedly within the latch case 1. It has an open frame which is rigid except for a pair of resiliently deformable fingers 933, 934 which define a central stop 932. The cam guide 930 has a circular opening for receiving the spindle of the rotary driving and indexing member 906, and the associated gear 905, on the axis 940. Cam surfaces 936, 937 and 938 extend inwardly from the outer frame of the cam guide 930, at each end, and these ends also define end walls. An inner wall 939 is also provided at each end. The cam guide is symmetrical, so that each end is the mirror image of the other. It defines the discrete sectoral zones of the required rotation of the driving and indexing member; a central zone 961 and adjacent end zones 960, 962. The cam guide 930 at each end provides a loop for the uni-directional movement of a cam pin 941 which rotates with the driving and indexing member. This loop 931 is illustrated at one end in FIG. 16. At each stage of motion around the loop, the cam pin 941 slides along the guiding surface at a progressively varying axial depth. From the lowest depth 935, an inclined cam surface 936 rises to a high level 937, which then drops at a shoulder to a lower level 938 which then drops at a further shoulder back to the lowest level 935. The shoulders prevent reverse motion of the pin 941. Further, the inner wall 939 guides the pin in the required sequence around the loop 931.

The cam pin 941 is carried by a cam frame 950 having two arms 951, 952 connected to a main body 953 with a part circular opening 954 disposed over the spindle of the driving and indexing member on the axis 940; a flat 955 locks the cam frame 950 to the spindle, so that it rotates with the driving and indexing member. The cam frame 950 is rotatable in a plane overlying the plane of the cam guide 930, and the frame 950 is deformable and is resiliently biased towards the cam guide 930, so that the pin 941 is biased onto the cam track 931. Further, the pin is resiliently biased radially outwardly, i.e. away from the central stop 932. Sequential positions of the cam pin 941 around the loop 931 are illustrated as circles in FIG. 17.

In a slightly different configuration shown in FIGS. 18 and 19 from different sides, corresponding reference numerals are primed.

With the driving and indexing member at the rotary position shown in FIG. 17, i.e. in the end zone 960, the electric motor may control the latch functions appropriate to that zone, and may move once or more than once between zones 960 and 961 whilst the cam pin follows the loop 931. This is controlled as follows. Motion of the cam pin 941 from cam surface 938 across to the lowest depth 935 and to finger 933 of the central stop causes the pin 941 to rest against the central stop for a predetermined interval. A lip, shown most clearly as 932′ in FIG. 18, is provided at the end of each finger, and is shaped to resist radial motion of the cam pin 941 for as long as there is torque acting on it and pushing it against the central stop. Since continued motion of the gearing arrangement is stopped, the centrifugal clutch disengages the electric motor after a predetermined interval, and the radial spring bias of the cam frame 950 pushes the pin 941 outwardly within the central zone 961. It rests at that central zone until the electric motor drive re-engages, in one or other of the rotational directions, to drive the driving and indexing member into zone 960 or 962 as required.

It will be appreciated that this arrangement provides mechanical time controlled sequencing of the motor operation, avoiding the need for position sensors anywhere in the latch, even on the indexing wheel. However, the latch described with reference to FIGS. 1 to 15 is operable, in other embodiments, without this time controlled sequencing, using appropriate positional feedback, using for example magnetic sensors on the indexing wheel, and Hall effect sensors elsewhere.

In this example, many of the components are plastics mouldings, minimising the weight of the latch. The latch bolt requires the strength of steel, but is covered with a plastics shield. Wherever possible, the rotary components share a common pivot axis, simplifying the structure, the pivots being riveted to the opposed plates of the steel case 1. The assembly embodying this invention allows sharing of pivots by plural components. In one example, a pivot is shared by segment gear 909, the three sliders 520, 620, 920 and a return spring for the gear. The lock toggle levers share the same pivot. The pawl, dogs and handle release levers share the same pivot. The simplicity of function and location of the latch components allows the latch to be assembled by an automated assembly line which requires no complex turning or other handling procedures: the assembly movements are entirely Cartesian.

The use of many parts common to many embodiments of the invention, being alternative versions to suit different combinations of latch functions as required, makes them economical to manufacture. The latch is modular in this respect: for example, removal of the two segment gears to produce a latch according to the second embodiment, can be achieved without redesigning the latch housing, simply by replacing them with spacers. The same automated assembly system may be used for all versions.

1. A latch arrangement for engaging an automotive door or other closure to a striker (4), comprising:
an electric motor (9);
a driving and indexing member (906) coupled to be driven by the motor and having at least one projection (9061-9064) extending therefrom;
a latch bolt (2) displaceable between a latched position at which it engages the striker and an unlatched position at which it releases the striker, and being selectively drivingly coupled to the driving and indexing member;
a pawl (3) operative to latch or unlatch the latch bolt; an actuation member (920) coupled to the pawl for causing it to unlatch the latch bolt and arranged to be driven by the projection (9063) or by one of the projections;
whereby the driving and indexing member is driveable electrically to cause the projection or projections to drive the actuation member to cause the pawl to unlatch the latch bolt to open the door or other closure;
the arrangement being such that continued motion of the driving and indexing member beyond the position at which it drives the actuation member causes it to drive the latch bolt, whereby the door or closure may be drawn to a fully closed position under the power of the motor;
the driving and indexing member being coupled to the latch bolt by means of a reduction gearing (907, 908) which is disengaged over a rotary range of the driving and indexing member at which it drives the actuation member.

2. A latch arrangement according to claim 1, comprising at least one pawl release assembly (514, 510) coupled to the pawl (3) for causing it to unlatch the latch bolt (2); and at least one coupling member (520, 620), each being associated with a respective pawl release assembly and movable between a locking position, at which it disengages the corresponding pawl release assembly from the pawl, and an unlocking position at which it engages the corresponding pawl release assembly with the pawl;
the coupling member also being arranged to be driven between its locking and unlocking positions by one of the projections (9061, 9062); in which the driving and indexing member (906) is arranged to drive the coupling member or members within the said rotary range.

3. A latch arrangement according to claim 2, in which the driving and indexing member (906) is arranged to drive the coupling member or members (520, 620) and the actuation member (920) all at different rotary positions.

4. A latch arrangement according to claim 1, in which the reduction gearing comprises a first segment gear (907).

5. A latch arrangement according to claim 4, in which the first segment gear (907) meshes with a bolt drive gear (908) which has a projection (909) arranged to drive the latch bolt (2).

6. A latch arrangement according to claim 5, in which the ratio of the radius at which the latch bolt is driven to the radius at which it engages the striker, in use, exceeds 2.

7. A latch arrangement according to claim 6, in which the said ratio is between 2 and 4.

8. A latch arrangement according to claim 7, in which the said ratio is about 3.

9. A latch arrangement according to claim 5, in which the bolt drive gear (908) is a second segment gear.

10. A latch arrangement according to claim 9, in which the gear reduction ratio between the first and second segment gears is between 2 and 4.

11. A latch arrangement according to claim 10, in which the gear reduction ratio is between 2 and 3.

12. A latch arrangement according to claim 11, in which the gear reduction ratio is about 2.5.

13. A latch arrangement according to claim 1, in which the electric motor is arranged to drive the driving and indexing member (906) through reduction gearing with a ratio of between 40 and 100.

14. A latch arrangement according to claim 13, in which the said ratio is between 40 and 80.

15. A latch arrangement according to claim 14, in which the ratio is between 50 and 70.

16. A latch arrangement according to claim 15, in which the ratio is about 60.

17. A latch arrangement according to claim 13, comprising a first gear (903) in meshing engagement with a gear (902) on the motor spindle, and a second gear (905) in meshing engagement with a pinion (904) which rotates with the first gear, the second gear rotating with the driving and indexing member (906).

18. A latch arrangement according to claim 1, in which the electric motor (9) drives the driving and indexing member (906) through a centrifugal clutch (901), whereby the motor decouples at speeds below a predetermined threshold.

19. A latch arrangement according to claim 1, in which the operation of all the functions of the driving and indexing member (906) is carried out within a single turn, or 360° of rotation, of that driving and indexing member, which is rotary.

20-37. (canceled)

38. A latch arrangement for engaging an automotive door or other closure to a striker (1), comprising:
an electric motor (9);
a latch bolt (2) displaceable between a latched position at which it engages the striker and an unlatched position at which it releases the striker;
a pawl (3) operative to latch or unlatch the latch bolt;
a driving and indexing member (906) coupled to be driven by the motor and having at least one projection (9061-9064) extending therefrom;
at least two pawl release assemblies (514, 510) coupled to the pawl for causing it to unlatch the latch bolt;
at least two coupling members (520, 620), each being associated with a respective pawl release assembly and moveable between a locking position, at which it disengages the corresponding pawl release assembly from the pawl, and an unlocking position at which it engages the corresponding pawl release assembly with the pawl;
each of the coupling members being arranged to be driven between its locking and unlocking positions by the projection or by one of the projections;
whereby the driving and indexing member is driveable electrically to cause the projection or projections selectively to drive the coupling members to engage the pawl release assemblies;
and levers (516) connectable, in use, to respective handles for opening the door by unlatching the latch bolt;
each pawl release assembly being moveable between a first position, at which it allows the corresponding lever to turn the pawl to release the latch bolt, and a second position at which it prevents the lever so doing;
the pawl assemblies having co-operating formations (517, 617) arranged such that manual operation of either handle, when unlocked, to cause the corresponding lever to open the door or other closure, causes the corresponding pawl release assembly to move the other pawl release assembly to its unlocked, pawl-engaging position, if that other pawl release assembly had been at its locked, pawl non-engaging position.

39. A latch arrangement according to claim 38, in which each pawl release assembly comprises a rotary toggle lever (510, 610) spring-biased to either of two stable rotary positions, corresponding to the stable positions of the pawl release assembly, by an over-centre spring arrangement (516).

40. A latch arrangement according to claim 39, in which the pawl release assembly comprises a pin (514) carried by the rotary toggle lever, the pawl being connected to or integral with a dog (302, 304) having a radially-extending track (303, 305) in which the pin rides, for engaging the lever to the pawl only at a predetermined range of radii of the pin, at the unlocked, stable position of the rotary toggle lever.

41. A latch arrangement according to claim 40, in which rotary toggle lever has a projection (517, 617), constituting one of said co-operating formations, engageable with the pin (514) carried by the other rotary toggle lever, for camming the first said rotary toggle lever towards its unlocked, stable, rotary position.

42. A latch arrangement according to claim 39, in which the camming of the first said rotary toggle lever acts to move it just beyond its over-centre position so that its over-centre spring completes its motion to the unlocked stable position.

43. A latch arrangement according to claim 38, comprising levers (5, 6) connectable, in use, to respective sill knob and key controls for manual locking respectively of one pawl release assembly, corresponding to the interior handle, and of both pawl-release assemblies, corresponding to interior and exterior handles, the arrangement being such that opening by the interior handle ensures that the exterior handle operation is unlocked; and that opening by the exterior handle ensures that the interior handle operation is unlocked.
